(19) United States
(12) Patent Application Publication
(10) Pub. No.: US 2024/0093713 A1
(43) Pub. Date: Mar. 21, 2024

(54) CONSTRUCTION SYSTEM, CONSTRUCTION METHOD, AND U-BOLT

(71) Applicant: NIPPON TELEGRAPH AND TELEPHONE CORPORATION, Tokyo (JP)

(72) Inventors: Toshiki NAKANISHI, Tokyo (JP); Daiki KOBAYASHI, Tokyo (JP); Atsushi ARATAKE, Tokyo (JP)

(73) Assignee: NIPPON TELEGRAPH AND TELEPHONE CORPORATION, Tokyo (JP)

(21) Appl. No.: 18/272,997

(22) PCT Filed: Jan. 21, 2021
(86) PCT No.: PCT/JP2021/002076

§ 371 Date: Jul. 18, 2023

(51) Int. Cl. F16B 31/02; F16B 35/04

(52) U.S. Cl. CPC F16B 31/02; F16B 35/041

(57) ABSTRACT

An installing system (100) according to the present disclosure includes a U-bolt (10) which includes a pair of shaft parts (11) aligned in a first direction and extending in a second direction orthogonal to the first direction, and a bridge part (12) that connects one ends of each of the pair of shaft parts (11); and a measurer (20), in which a strain gauge (14) which outputs a signal corresponding to a strain of the shaft parts (11) in the second direction is embedded in each of the pair of shaft parts (11), in line symmetry with respect to a straight line (OX) including an apex (0) of the U-shape and extending in the second direction, and the measurer (20) measures the strain of each of the pair of shaft parts (11) in the second direction, from an output signal of the strain gauge (14) embedded in each of the pair of shaft parts (11).

### TECHNICAL FIELD

The present disclosure relates to an installing system, an installing method, and a U-bolt.

### BACKGROUND ART

In the related art, a U-bolt has been used to fix a fastening object such as a pipe to a fastening object such as a frame or a wall surface. The U-bolt is a U-shaped bolt in which two linear shaft parts are connected by a bridge part. By inserting the shaft parts of the U-bolt into each of two through-holes provided in the fastened object to in a state of the fastening object being sandwiched inside the U-bolt, and fastening from each end part of the two shaft parts with a nut, the fastening object can be sandwiched and fixed by the U-bolt and the fastened object.

When the fastening object is fixed to the fastened object to by the U-bolt, it is necessary to fix the U-bolt perpendicularly to the fastened object. However, since the U-bolt can only be tightened with the nut by one of the two shaft parts, it is difficult to evenly fix the U-bolt on the left and right.

ε of shaft parts A and B (strain ε_{A} of a shaft part A and strain ε_{B} of a shaft part B), when one (shaft part A) of the two shaft parts is first tightened with a torque wrench and then the other shaft (shaft part B) is tightened with the torque wrench.

As shown in FIG. 15, the shaft part A which has been tightened first is tightened more with a smaller torque than the shaft part B. That is, the relationship between the strain and the torque does not match between the right and left shaft parts A and B. Therefore, even if the fastening force of the nuts is controlled by the torque wrench, since the nuts are alternately fastened on the two shaft parts, it is difficult to fix the U-bolt by uniformizing the strain of the two shaft parts due to a difference in correlation between the strain and the torque in the shaft parts A and B.

As shown in FIG. 16, NPL 1 discloses a technique for stably fixing a U-bolt to make it unlikely for displacement in a vertical direction (an extending direction of the shaft part) to be caused, by machining a tip of the shaft part of the bolt into a tapered shape.

### CITATION LIST

### Non Patent Literature

[NPL 1] Takeshi Yamada, 4 others, “Structural characteristics of steel plate-concrete composite floor slabs using checkered steel plates and U-bolts to prevent slipping”, Proceedings of the 3rd Symposium on Decks of Highway Bridge, p 79-84, 2003

### SUMMARY OF INVENTION

### Technical Problem

When the U-bolt is fixed to a fastening object, as shown in FIG. 17, a displacement in a horizontal direction (a lateral direction) occurs, and the U-bolt may be fixed in a state of being inclined in the horizontal direction. The technique described in the above-mentioned NPL 1 is a technique for making it difficult to cause a vertical displacement, and it is difficult to suppress horizontal displacement and to fix the U-bolt by uniformizing the strains of the two shaft parts. In addition, when the U-bolt is used in an infrastructure facility, since periodic inspection and repair are required, if the U-bolt body is formed into a complicated structure, it takes time and labor for inspection and repair.

An object of the present disclosure made in view of the above-mentioned problems is to provide an installing system, in which a U-bolt is able to be fixed by uniformizing the strain of each of a pair of shaft parts, while curbing complication of a structure of the U-bolt, an installing method, and a U-bolt.

### Solution to Problem

In order to solve the above problem, an installing system according to the present disclosure includes a U-shaped U-bolt which includes a pair of shaft parts aligned in a first direction and extending in a second direction orthogonal to the first direction, and a bridge part that connects one ends of each of the pair of shaft parts; and a measurement device, in which a strain gauge which outputs a signal corresponding to a strain of the shaft part in the second direction is embedded in each of the pair of shaft parts, in line symmetry with respect to a straight line including an apex of the U-shape and extending in the second direction, and the measurement device measures the strain of each of the pair of shaft parts in the second direction, from an output signal of the strain gauge embedded in each of the pair of shaft parts.

In addition, in order to solve the above problem, an installing method according to the present disclosure is an installing method for fixing a U-shaped U-bolt to a fastening object, using a measurement device, the U-bolt including a pair of shaft parts aligned in a first direction and extending in a second direction orthogonal to the first direction, and a bridge part that connects one ends of each of the pair of shaft parts, in which in the U-bolt, a strain gauge which outputs a signal corresponding to a strain of the shaft part in the second direction is embedded in each of the pair of shaft parts, in line symmetry with respect to a straight line including an apex of the U-shape and extending in the Y-axis direction, and the method includes a step of acquiring an output signal of the strain gauge embedded in each of the pair of shaft parts; and a step of measuring strain in the second direction of each of the pair of shaft parts from the acquired signal.

In addition, in order to solve the above problem, a U-bolt according to the present disclosure is an U-shaped U-bolt which includes a pair of shaft parts aligned in a first direction and extending in a second direction orthogonal to the first direction; and a bridge part that connects one ends of each of the pair of shaft parts, in which the U-shaped U-bolt includes a strain gauge which is embedded in each of the pair of shaft parts in line symmetry with respect to a straight line including an apex of the U-shape and extending in the Y-axis direction, and outputs a signal corresponding to a strain of the shaft part in the second direction.

### Advantageous Effects of Invention

According to the installing system, the installing method, and the U-bolt according to the present disclosure, the U-bolt can be fixed by making strain of each of the pair of shaft parts uniform, while suppressing complication of a structure of the U-bolt.

### BRIEF DESCRIPTION OF DRAWINGS

FIG. 1 is a diagram showing a configuration example of a U-bolt according to an embodiment of the present disclosure.

FIG. 2 is a diagram showing a state in which a fastening object is sixed to a fastened object with the U-bolt shown to FIG. 1.

FIG. 3 is a cross-sectional view of the shaft part of the U-bolt shown in FIG. 1 as viewed from a Y-axis direction.

FIG. 4 is a diagram showing an example of a planar shape of the strain gauge shown in FIG. 1.

FIG. 5A is a diagram showing an example of an embedding position of the strain gauge shown in FIG. 1.

FIG. 5B is a diagram showing another example of the embedding position of the strain gauge shown in FIG. 1.

FIG. 5C is a diagram showing still another example of the embedding position of the strain gauge shown in FIG. 1.

FIG. 6 is a diagram showing a configuration example of an installing system according to an embodiment of the present disclosure.

FIG. 7 is a diagram showing an example of a configuration in which a measurer acquires an output signal of a strain gauge.

FIG. 8 is a diagram showing an example of a configuration in which a measurer acquires output signals of strain gauges provided on a plurality of U-bolts.

FIG. 9 is a diagram showing a configuration example of a U-bolt and a measurer when the measurer acquires the output signal of the strain gauge by wireless communication.

FIG. 10 is a diagram showing another configuration example of the measurer shown in FIG. 9.

FIG. 11 is a diagram showing still another configuration example of the measurer shown in FIG. 9.

FIG. 12 is a diagram showing an example in which a measurer acquires output signals of strain gauges provided on a plurality of U-bolt through wireless communication.

FIG. 13 is a diagram showing another configuration example of U-bolt when the measurer acquires the output signal of the strain gauge by wireless communication.

FIG. 14 is a flowchart showing an example of operation of the installing system according to an embodiment of the present disclosure.

FIG. 15 is a diagram showing an example of a relationship between torque and strain of the shaft part.

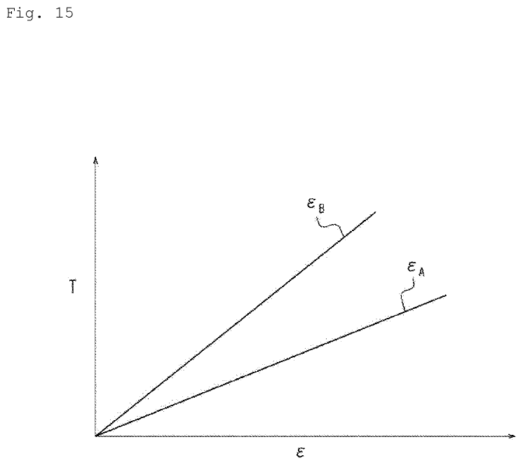

FIG. 16 is a diagram showing a vertical displacement of the shaft part of the U-bolt.

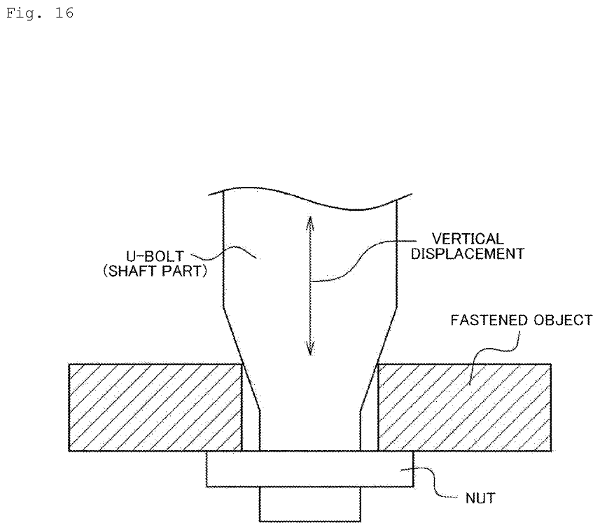

FIG. 17 is a diagram showing a horizontal displacement of the shaft part of the U-bolt.

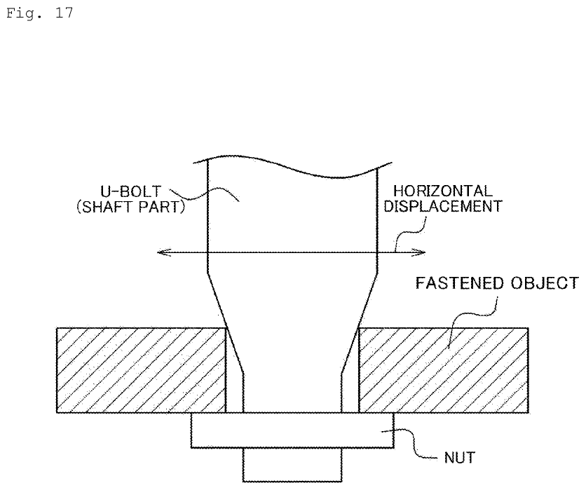

### DESCRIPTION OF EMBODIMENTS

A description will be given below of embodiments of the present disclosure with reference to the drawings.

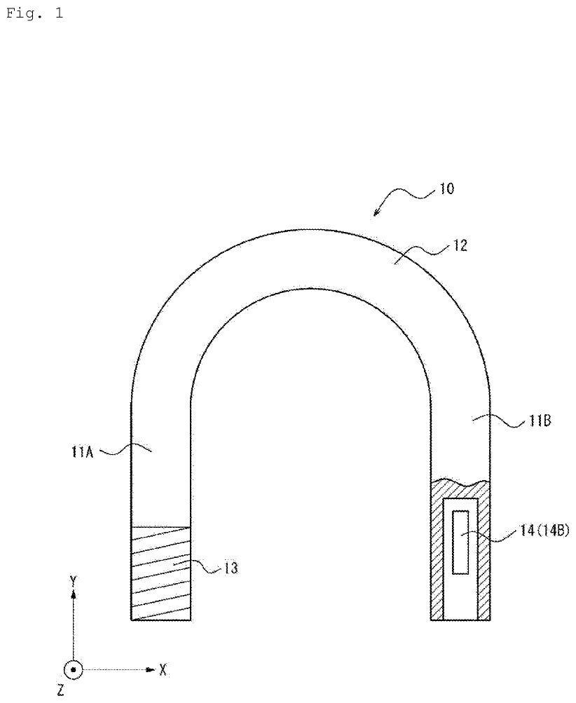

FIG. 1 is a diagram showing a configuration example of a U-bolt 10 according to an embodiment of the present disclosure.

As shown in FIG. 1, the U-bolt 10 according to the present embodiment includes a pair of shaft parts 11A and 11B and a bridge part 12.

The shaft parts 11A and 11B are aligned in a predetermined direction and extend in a direction orthogonal to the predetermined direction. Hereinafter, as shown in FIG. 1, a direction in which the shaft parts 11A and 11B are aligned side by side is referred to as an X-axis direction (a first direction), a direction in which the shaft parts 11A and 11B extend is referred to as a Y-axis direction (a second direction), and a direction orthogonal to the X-axis direction and Y-axis direction is referred to as a Z-axis direction (a third direction). Hereinafter, when the shaft parts 11A and 11B are not distinguished from each other, they are referred to as a shaft part 11. Hereinafter, the shaft parts 11A and 11B are collectively referred to as a pair of shaft parts 11.

One end of the shaft part 11A and one end of the shaft part 11B are connected by a bridge part 12 having a shape curved in a semicircular shape. One end of the shaft part 11A and one end of the shaft part 11B are connected by the bridge part 12, and the U-bolt 10 forms a U-shape. A screw part 13 having a screw thread structure is formed on the other end side of each shaft parts 11A and 11B. In FIG. 1, for simplification of the drawing, illustration of the screw part 13 formed on the shaft part 11B is omitted.

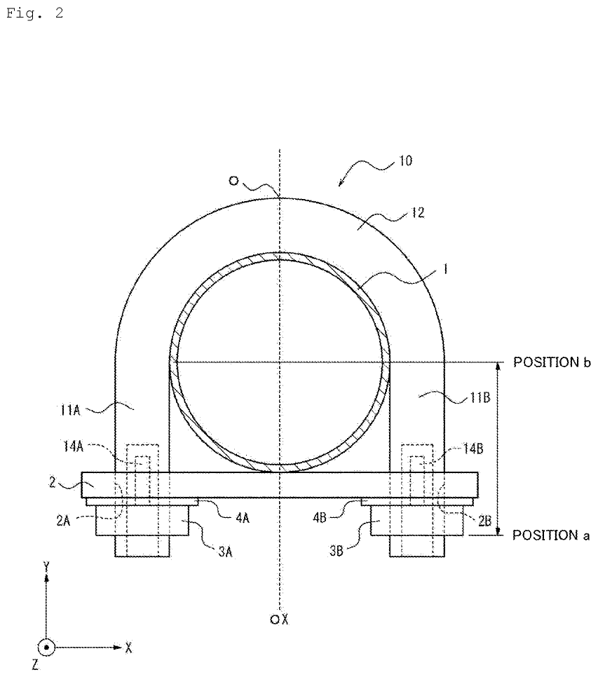

As shown in FIG. 2, a fastening object 1 such as a pipe is disposed inside the U-shaped U-bolt 10 (in a space surrounded by the pair of shaft parts 11 and the bridge part 12). In a state in which the fastening object 1 is disposed inside, the shaft parts 11A and 11B are inserted into a pair of through-holes 2A and 2B provided in the fastened object 2 such as support hardware from one surface side of the fastened object 2. When the shaft parts 11A and 11B are inserted into the through-holes 2A and 2B, the screw part 13 of the shaft parts 11A and 11B protrude to the other surface side of the fastened object 2. When nuts 3A and 3B having a screw thread structure to be screwed to the screw thread structure of the screw part 13 are fastened via washers 4A and 4B to the screw part 13 (not shown in FIG. 2) of the shaft parts 11A and 11B protruding from the other surface side of the fastened object 2, the fastening object 1 is fixed by being sandwiched between the U-bolt 10 and the fastened object 2. Hereinafter, when no distinction is made between the nuts 3A and 3B, they are referred to as a nut 3.

As shown in FIG. 1, the U-bolt 10 according to the present embodiment further includes a strain gauge 14. The strain gauge 14 is embedded inside the shaft part 11. Although only the strain gauge 14 embedded in the shaft part 11B is shown in FIG. 1, actually, as shown in FIG. 2, the strain gauges 14 are embedded in both the shaft part 11A and the shaft part 11B. Hereinafter, the strain gauge 14 embedded in the shaft part 11A is referred to as a strain gauge 14A, and the strain gauge 14 embedded in the shaft part 11B is referred to as a strain gauge 14B.

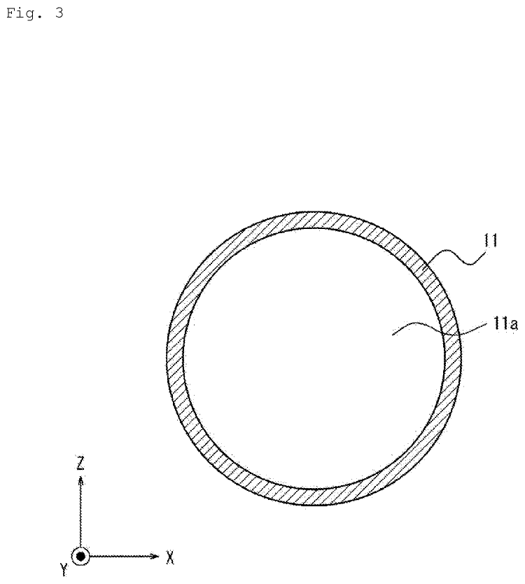

FIG. 3 is a diagram of the shaft part 11 viewed from the Y-axis direction. In the shaft part 11, a hole 11a (for example, a circular hole) extending from the other end side of the shaft part 11 in the Y-axis direction is formed up to an embedding position of the strain gauge 14. The strain gauge 14 is embedded in the hole 11a formed in the shaft part 11.

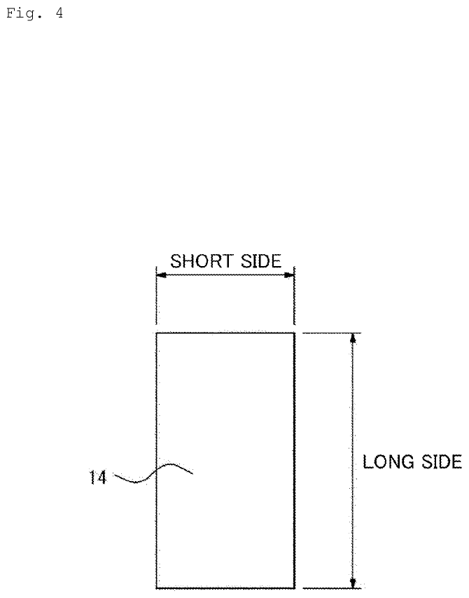

FIG. 4 is a diagram showing an example of a planar shape of the strain gauge 14. As shown in FIG. 4, the strain gauge 14 has a rectangular shape. An inner diameter of a hole 11a formed in the shaft part 11 is longer than a length of the short side of the strain gauge 14. Therefore, the strain gauge 14 can be embedded in the hole 11a formed in the shaft part 11 along a long side direction of the strain gauge 14. After the strain gauge 14 is embedded in the hole 11a formed in the shaft part 11, the hole 11a is filled with an adhesive. Thus, the strain gauge 14 is embedded and fixed in the shaft part 11. As the adhesive, an epoxy-based adhesive having high adhesive strength and suitable for adhesion to a metal constituting the shaft part 11 is preferably used.

As shown in FIG. 2, the strain gauges 14A and 14B are embedded in each of the pair of shaft parts 11 in line symmetry with respect to a straight line OX which includes the apex of the U-shape of the U-bolt 10 and extends in the Y-axis direction. That is, the strain gauges 14A and 14B are embedded at the same position in the Y direction of the shaft parts 11A and 11B.

Further, as shown in FIG. 2, in a state in which the U-bolt 10 is fixed to the fastened object 2, the strain gauge 14 is embedded between a position a, which is a fastening position between the nut 3 and the shaft part 11 (specifically, a position of the surface of the nut 3 opposite to the fastened object 2), and a position of contact point between the fastening object 1 and the U-bolt 10 (a position b).

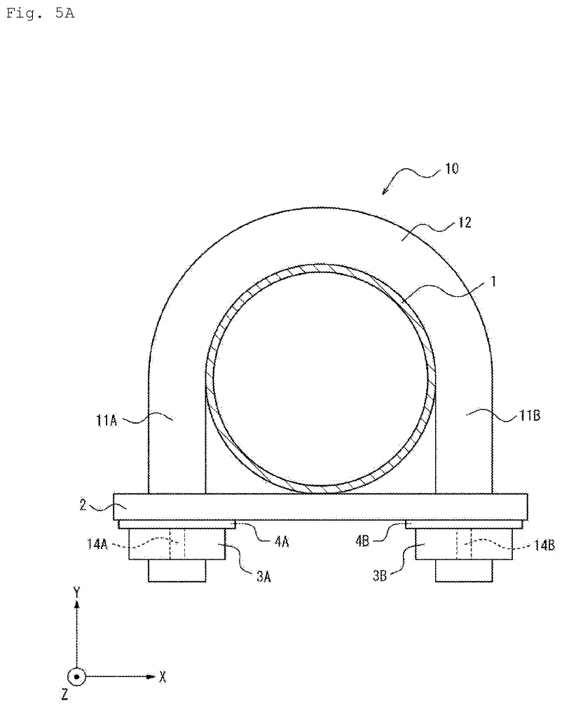

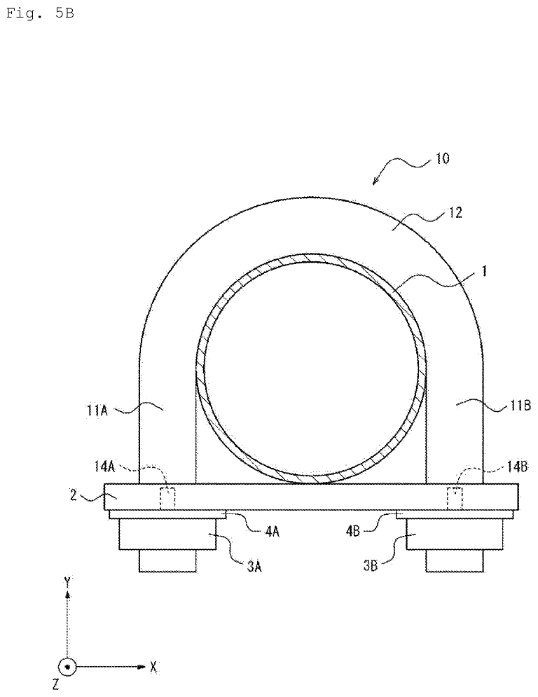

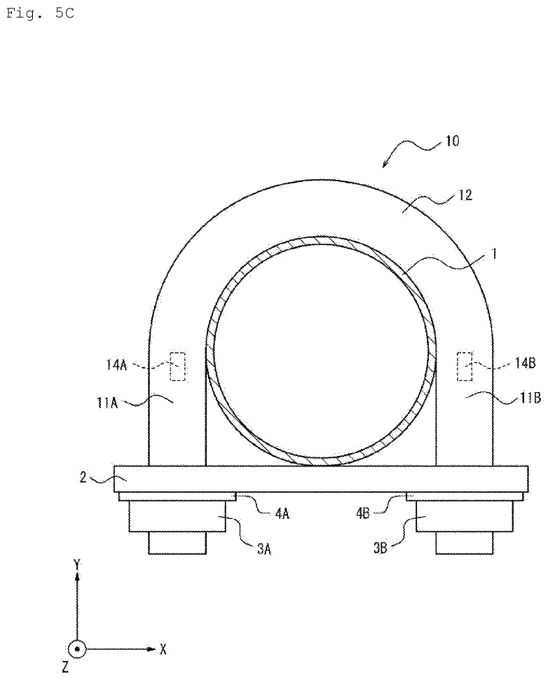

Therefore, as shown in FIG. 5A, the strain gauge 14 may be embedded in the shaft part 11 such that the nut 3 is positioned around the fastening part fastened to the shaft part 11, in a state in which the U-bolt 10 is fixed to the fastened object 2. Further, as shown in FIG. 5B, the strain gauge 14 may be embedded in the shaft part 11 to be positioned above the fastening portion of the nut 3 and near the fastened object 2. As shown in FIG. 5C, the strain gauge 14 may be embedded in the shaft part 11 to be positioned on a contact point between the fastened object 2 and the U-bolt 10 and near the contact point.

The strain gauge 14 is deformed (tensioned and compressed) depending on the strain in the Y-axis direction of the shaft part 11 in which the strain gauge 14 is embedded, and outputs a signal (voltage signal) corresponding to the deformation. As described above, the strain gauge 14 may be embedded between the fastening position between the nut 3 and the shaft part 11, and the position of the contact point between the fastening object 1 and the U-bolt 10, in a state in which the U-bolt 10 is fixed to the fastened object 2. However, since the strain of the shaft part 11 is maximum in the vicinity of the fastened object 2 above the fastening part of the nut 3, the strain gauge 14 is preferably embedded in the shaft part 11 to be positioned above the fastening part of the nut 3 and near the fastened object 2 as shown in FIG. 5B.

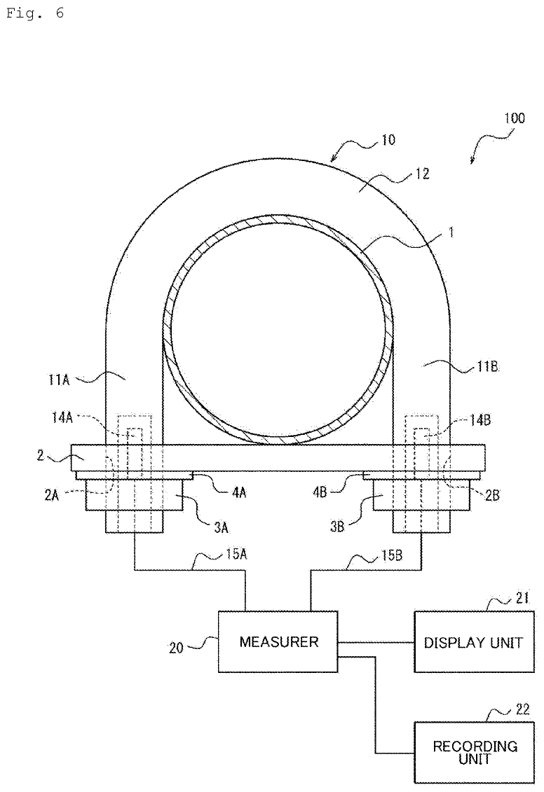

Next, a configuration of an installing system 100 according to the embodiment of the present invention will be described with reference to FIG. 6. The installing system 100 according to the present embodiment is for fixing the U-bolt 10 to the fastened object 2 so that the fastening object 1 is fixed to the fastened object 2. As described above, in order to stably fix the U-bolt 10 to the fastened object 2, it is necessary to equalize the strain of each of the shaft parts 11. The installing system 100 according to the present embodiment is intended to fix the U-bolt 10 to the fastened object 2 in a state in which the strain of the shaft parts 11A and 11B is uniform, by measuring the strain of each of the pair of shaft parts 11, using strain gauges 14 embedded in each of the pair of shaft parts 11 of the U-bolt 10.

As shown in FIG. 6, the installing system 100 according to the present embodiment includes a U-bolt 10, a measurer 20 as a measuring device, a display unit 21, and a recording unit 22.

The measurer 20 measures the strain in the Y-axis direction of each of the pair of shaft parts 11 from the output signal of the strain gauge 14 embedded in each of the pair of shaft parts 11 of the U-bolt 10. As shown in FIG. 6, a wiring 15A connected to the strain gauge 14A is drawn out from the other end of the shaft part 11A. A wiring 15B connected to the strain gauge 14B is drawn out from the other end of the shaft part 11B. The measurer 20 is connected to the wirings 15A and 15B, and acquires an output signal of the strain gauges 14A and 14B via the wirings 15A and 15B.

The measurer 20 measures the strain of each of the pair of shaft parts 11 from the acquired output signal of the strain gauges 14A and 14B, and outputs the measurement result to the display unit 21 and the recording unit 22.

A strain corresponding to the fastening force of the nut 3 to the shaft part 11 in which the strain gauge 14 is embedded is generated in the shaft part 11, and the strain gauge 14 outputs a signal corresponding to the strain. When the nut 3 is fastened to one shaft part 11 of the pair of shaft parts 11, fastening force of the nut 3 fastened to the other shaft part 11 also changes. Therefore, when the U-bolt 10 is fixed, it is preferable to fasten the nut 3, while simultaneously measuring the strain of each of the pair of shaft parts 11. As shown in FIG. 6, the wiring 15A connected to the strain gauge 14A and the wiring 15B connected to the strain gauge 14B are connected to the measurer 20, and the output signals of the strain gauges 14A and 14B are acquired via the wirings 15A and 15B. Accordingly, the measurer 20 can simultaneously measure the strain of each of the pair of shaft parts 11. Further, since there is no need to measure the strain of each of the pair of shaft parts 11 separately (two times), the working efficiency can be improved.

The display unit 21 is, for example, a liquid crystal display, and displays the measurement result of the measurer 20. The display unit 21 displays, for example, a difference in strain between the pair of shaft parts 11. A worker who fixes the U-bolt 10 to the fastened object 2 adjusts fastening of the nut 3 to each of the pair of shaft parts 11 so that the difference displayed on the display unit 21 becomes 0 by displaying the difference of the strain of each of the pair of shaft parts 11, makes the strain of each of the pair of shaft parts 11 uniform, and can fix the U-bolt 10 to the fastened object 2.

The recording unit 22 records the strain measurement results of the pair of shaft parts 11 by the measurer 20. The recording unit 22 is made up of an arbitrary recording medium, such as a read only memory (ROM), a random access memory (RAM), a hard disk drive (HDD) or a solid state drive (SSD). By recording the measurement result obtained by the measurer 20 in the recording unit 22, the past installing situation can be inquired.

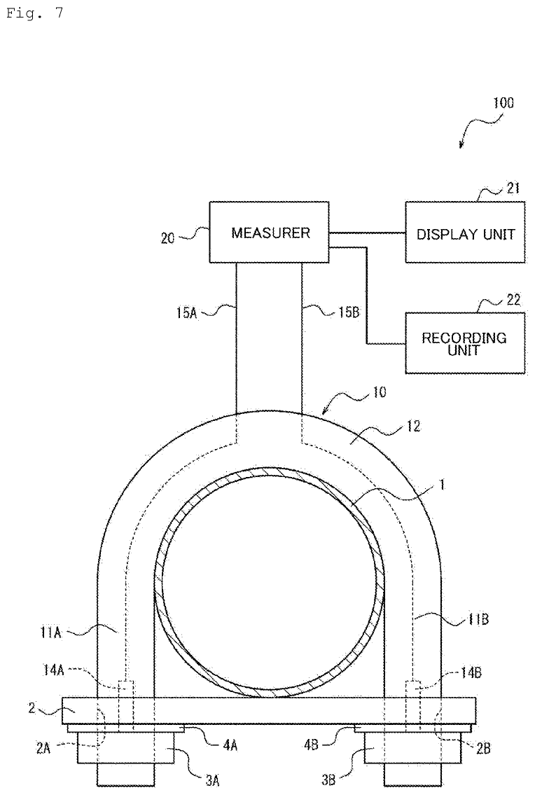

The configuration for the measurer 20 to acquire the output signal of the strain gauge 14 is not limited to the configuration shown in FIG. 6 in which the wiring 15 is drawn out from the other end of the shaft part 11, and for example, may be a configuration, as shown in FIG. 7, in which the wirings 15A and 15B are drawn out from the bridge part 12. In this way, the measurer 20 is connected to the strain gauge 14, and acquires an output signal of the strain gauge 14 via the wiring 15 drawn out from the shaft part 11 or the bridge part 12.

In the configuration that draws out the wiring 15 from the other end of the shaft part 11 as shown in FIG. 6, the time and labor for causing the wiring 15 to pass through the nut 3 occur when fastening the nut 3, and there is a risk of damage to the wiring 15 by a tool. On the other hand, in the configuration shown in FIG. 7 in which the wiring 15 is drawn out from the bridge part 12, the time and labor for causing the nut 3 to pass through the wiring 15 are eliminated, and the risk of damaging the wiring 15 by a tool is also reduced. Therefore, working efficiency and safety can be improved.

FIG. 7 shows a configuration in which the wirings 15A and 15B are drawn out from the vicinity of the apex of the semicircular bridge part 12, but the present disclosure is not limited to this. The wirings 15A and 15B may be drawn out from an arbitrary position of the shaft part 11 or the bridge part 12, unless the wirings 15A and 15B interfere with fixing of the U-bolt 10 to the fastened object 2.

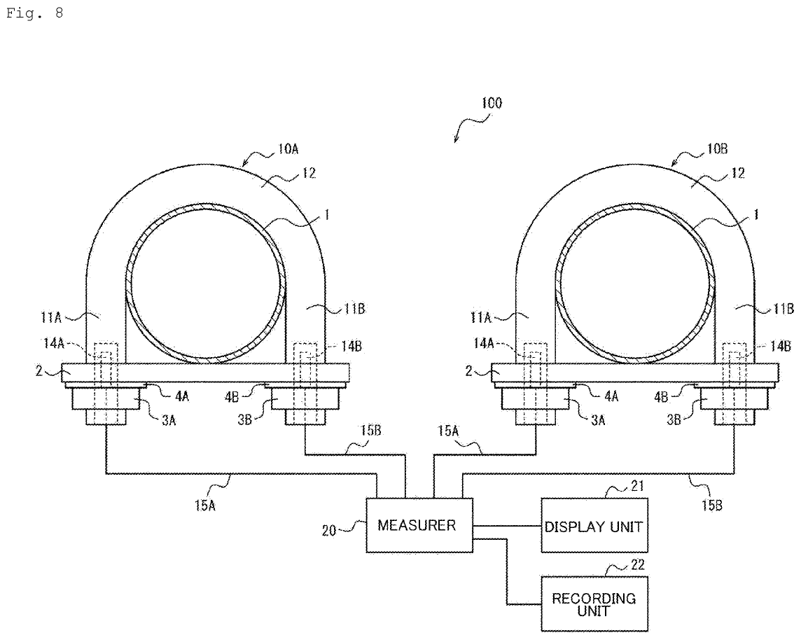

Further, the measurer 20 may acquire the output signals of the strain gauges 14 embedded in the respective pair of shaft parts 11 of the plurality of U-bolts 10, as shown in FIG. 8. Although FIG. 8 shows an example of acquiring output signals from the strain gauges 14 (four strain gauges 14) provided in each of the two U-bolts 10 (U-bolts 10A and 10B), the present disclosure is not limited thereto. The measurer 20 may acquire output signals of the strain gauges 14 provided in each of the three or more U-bolts 10.

As shown in FIG. 8, by acquiring the output signals of the strain gauges 14 provided in each of the plurality of U-bolts 10 with one measurer 20, it is possible to reduce the number of times of mounting the measurer 20 and the number of times of setting the measuring software mounted on the measurer 20.

When the output signal of the strain gauge 14 is acquired via the wiring 15, power can be supplied to the strain gauge 14 via the wiring 15. Therefore, it is not necessary to provide a power source or the like for supplying power to the strain gauge 14, and complication of the configuration can be suppressed. Further, by extending the wiring 15, the output signals of the strain gauges 14 provided in each of the plurality of U-bolts 10 can be easily acquired.

Although FIGS. 6 to 8 were explained, using the example in which the measurer 20 acquires the output signal of the strain gauge 14 via the wiring 15, the present disclosure is not limited thereto. The measurer 20 may acquire an output signal of the strain gauge 14 by radio communication.

In the configuration in which the output signal of the strain gauge 14 is acquired via the wiring 15 drawn out from the U-bolt 10, when the wiring 15 is drawn out from the other end of the shaft part 11. There is a problem of occurrence of time and labor for causing the nut 3 to pass through the wiring 15, as described above. Further, in a state in which the wiring 15 is drawn out from the U-bolt 10, there is a problem that the wiring 15 is deteriorated. For this reason, there is a case where the configuration in which the wiring 15 is drawn out from the U-bolt 10 is not suitable for infrastructure facilities which are expected to be used for a long period of time. The above-mentioned problem is not caused by a configuration in which the output signal of the strain gauge 14 is acquired by radio communication. In particular, semi-permanent operation is possible by adopting a configuration that allows wireless power supply from the measurer 20 to the U-bolt 10. The following describes a configuration in which the measurer 20 acquires an output signal of the strain gauge 14, by radio communication using power supplied from the measurer 20 to the U-bolt 10 by wireless power supply.

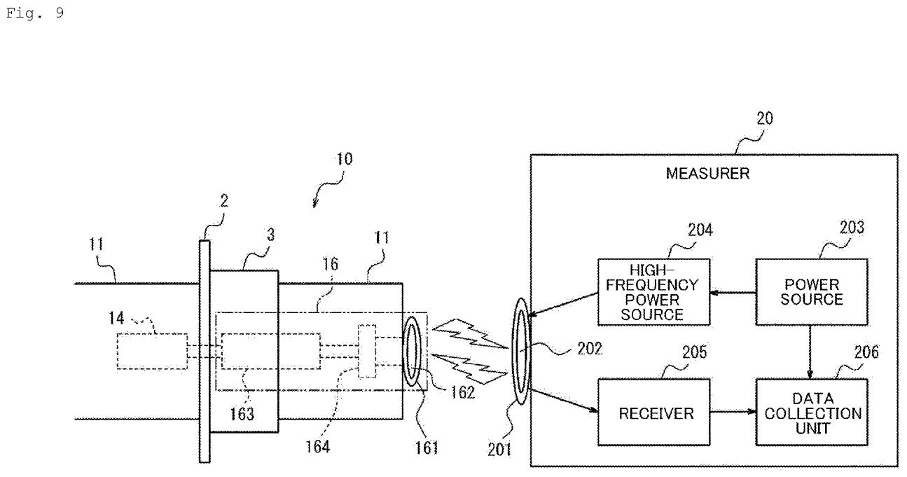

FIG. 9 is a diagram showing a configuration example of the U-bolt 10 and the measurer 20, when the measurer 20 acquires the output signal of the strain gauge 14 by radio communication using power supplied from the measurer 20 to the U-bolt 10 by wireless power supply. FIG. 9 shows a configuration related to radio communication in the configuration of the U-bolt 10, and the other configurations are not shown.

First, a description will be given of the configuration of the U-bolt 10.

As shown in FIG. 9, the U-bolt 10 includes a transmission unit 16 provided on the shaft part 11. The transmission unit 16 wirelessly transmits an output signal of the strain gauge 14. The measurer 20 receives (acquires) the output signal of the strain gauge 14 wirelessly transmitted from the transmission unit 16.

The transmission unit 16 includes a power reception coil 161, a transmission antenna 162, an amplifier 163, and a radio transmitter 164.

The power reception coil 161 receives power from the outside in a non-contact manner by wireless power supply via an electric field or a magnetic field. The power received by the power reception coil 161 is supplied to each part of the strain gauge 14 and the transmission unit 16.

An amplifier 163 amplifies an output signal of the strain gauge 14 and outputs the amplified signal to the radio transmitter 164.

The radio transmitter 164 is driven by power supplied via the power reception coil 161, and transmits the output signal of the strain gauge 14 amplified by the amplifier 163 via the transmission antenna 162. The transmission antenna 162 is disposed inside, for example, the power reception coil 161. The power reception coil 161 and the transmission antenna 162 are disposed, for example, to be exposed from one end of the shaft part 11.

Next, a configuration of the measurer 20 will be described.

As shown in FIG. 9, the measurer 20 includes a power transmission coil 201, a reception antenna 202, a power source 203, a high-frequency power source 204, a receiver 205, and a data collection unit 206.

The power transmission coil 201 is supplied with high-frequency power from a high-frequency power source 204, which will be described later, and transmits power to the power reception coil 161 by a method corresponding to the power reception coil 161.

The power source 203 supplies power to the high-frequency power source 204 and the data collection unit 206. The high-frequency power source 204 and the data collection unit 206 are driven by power supply from the power source 203.

The high-frequency power source 204 outputs high-frequency power of a predetermined frequency to the outside via the power transmission coil 201. When the power that is output from the high-frequency power source 204 via the power transmission coil 201 is received by the power reception coil 161, the strain gauge 14 and the transmission unit 16 are driven, and the output signal of the strain gauge 14 corresponding to the strain of the shaft part 11 is transmitted via the transmission antenna 162.

The receiver 205 receives the signal (the output signal of the strain gauge 14), which is transmitted via the transmission antenna 162, via the reception antenna 202 in response to an output of high-frequency power from the high-frequency power source 204, and outputs the reception signal to the data collection unit 206. The reception antenna 202 is disposed inside, for example, the power transmission coil 201. The power transmission coil 201 and the power reception antenna 202 are disposed, for example, to be exposed from the measurer 20.

The data collection unit 206 collects data related to strain of the shaft part 11 of the U-bolt 10. Specifically, the data collection unit 206 measures the strain of the shaft part 11 from the received signal of the receiver 205.

The measurer 20 shown in FIG. 9 supplies the power to the U-bolt 10 by wireless power supply, and receives the output signal of the strain gauge 14 transmitted from the transmission unit 16 in response to the power supply. Thus, the wiring 15 exposed to the outside of the U-bolt 10 is not required. Further, when measuring the strain of the shaft part 11, since the power supply and signal transmission and reception are performed by bringing the measurer 20 close to the U-bolt 10, the semi-permanent operation can be performed.

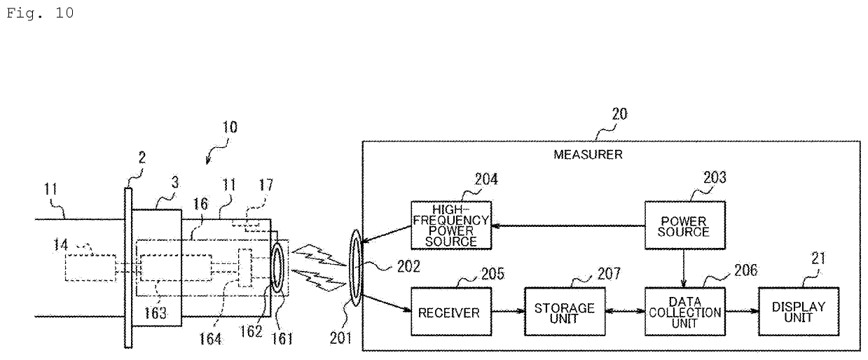

In the case where the U-bolts 10 are used in a ship, a power plant, a pipeline or the like, since a plurality of U-bolts 10 are usually used, it is necessary to identify each of the plurality of U-bolts 10. As a method for identifying each of the plurality of U-bolts 10, there is a method for setting identification information for each U-bolt 10 and transmitting the identification information set for the U-bolt 10 to the measurer 20 by radio communication. FIG. 10 shows an example of the configuration of the measurer 20 corresponding to such a method. In FIG. 10, the same configurations as those in FIG. 9 are denoted by the same reference numerals, and a description thereof will not be provided.

The measurer 20 shown in FIG. 10 further includes a storage unit 207 as compared with the measurer 20 shown in FIG. 9.

The storage unit 207 stores identification information set for each of the plurality of U-bolts 10. Further, the storage unit 207 stores data related to the strain of the shaft part 11 collected by the data collection unit 206 for the U-bolt 10 in association with the identification information of the U-bolt 10. By providing the storage unit 207, the past measurement data can be referred to for each of the plurality of U-bolts 10.

Further, the measurer 20 may include the display unit 21 as shown in FIG. 10. Since the measurer 20 includes the display unit 21, when fixing the U-bolt 10 to the fastened object 2, a worker can perform a work, while measuring the strain of the shaft part 11 by bringing the measurer 20 close to the U-bolt 10, and while checking the measurement result by the display unit 21. Therefore, the working efficiency can be improved.

As shown in FIG. 10, the U-bolt 10 may be provided with a lighting unit 17 such as a light emitting diode (LED) which lights up in response to power reception by the power reception coil 161 in a manner visible from the outside. By providing the lighting unit 17, when a worker brings the measurer 20 close to the U-bolt 10, power is supplied from the measurer 20 to the lighting unit 17 via the power reception coil 161, and the lighting unit 17 lights up. When the lighting unit 17 lights up, since a worker can easily grasp the position of the U-bolt 10, working efficiency can be improved even in a dark place such as a plant.

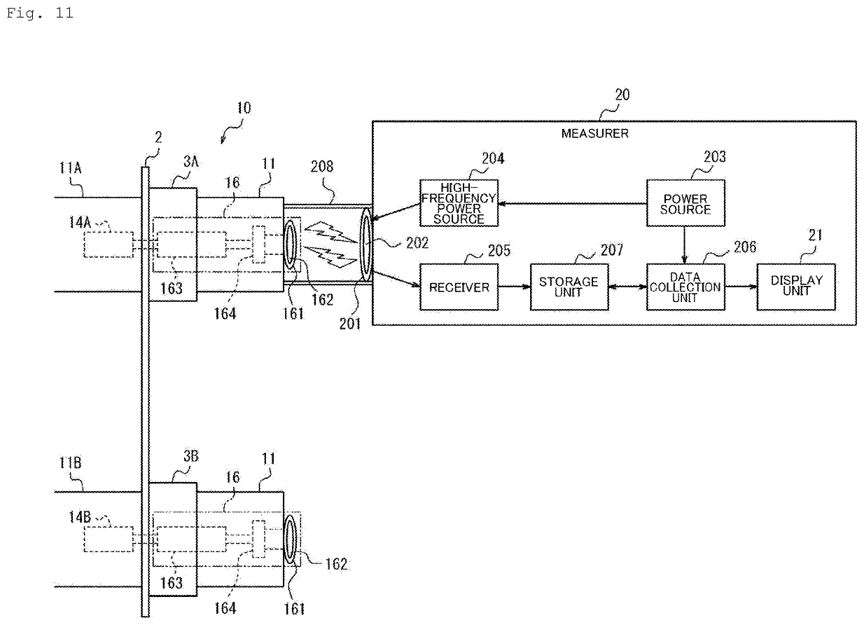

When the diameter of the U-bolt 10 is small, even if a worker brings the measurer 20 close to one shaft part 11, the measurer 20 is able to receive a signal from the transmission unit 16 provided on the other shaft part 11. Therefore, as shown in FIG. 11, a shield 208 which limits a receiving direction of the signal from the reception antenna 202 to a predetermined direction may be provided in the measurer 20. The shield 208 is made of, for example, a metal member.

By bringing the measurer 20 close to cover the transmission unit 16 (the transmission antenna 162) embedded in the shaft part 11 of the U-bolt 10 by the shield 208, the possibility of receiving the output signal from the strain gauge 14 embedded in the shaft part 11 not intended by a worker is reduced. Therefore, the accuracy of data can be improved.

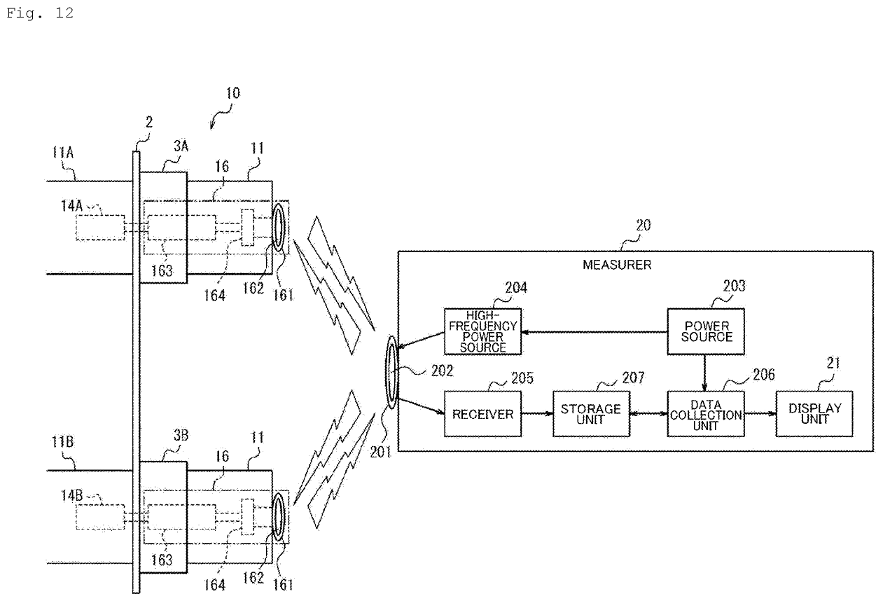

The measurer 20 may simultaneously acquire the output signal of the strain gauge 14A and the output signal of the strain gauge 14B by radio communication. The configuration of the measurer 20 for simultaneously acquiring the output signal of the strain gauge 14A and the output signal of the strain gauge 14B by radio communication will be described below with reference to FIG. 12.

As shown in FIG. 12, the measurer 20 outputs high-frequency power so that the power is received by the power reception coil 161 of the transmission unit 16 embedded in the shaft part 11A and the power reception coil 161 of the transmission unit 16 embedded in the shaft part 11B.

The transmission unit 16 embedded in the shaft part 11A and the transmission unit 16 embedded in the shaft part 11B transmit the output signal of the strain gauge 14, when receiving power from the measurer 20. Here, the transmission unit 16 embedded in the shaft part 11A and the transmission unit 16 embedded in the shaft part 11B wirelessly transmit the output signal of the strain gauge 14 at different frequencies.

The receiver 205 receives a signal transmitted from the transmission unit 16 embedded in the shaft part 11A and a signal transmitted from the transmission unit 16 embedded in the shaft part 11B via the reception antenna 202. As described above, the transmission unit 16 embedded in the shaft part 11A and the transmission unit 16 embedded in the shaft part 11B wirelessly transmit the output signal of the strain gauge 14 at different frequencies. Therefore, the signals transmitted from the respective transmission units 16 do not interfere with each other, and the receiver 205 can normally receive the signals transmitted from the respective transmission units 16. The receiver 205 can identify a transmission source by identifying the frequency of the received signal.

Since the signal transmitted from each transmission unit 16 is identified by the receiver 205, the data collection unit 206 can measure the strain of the shaft part 11A and the strain of the shaft part 11B at the same time.

The display unit 21 displays, for example, a difference between the strains of the pair of shaft parts 11 measured by the data collection unit 206. By displaying the difference of the strain of each of the pair of shaft parts 11, a worker adjusts fastening of the nut 3 to each of the pair of shaft parts 11 so that the difference displayed on the display unit 21 becomes zero, and can fix the U-bolt 10 to the fastened object 2 such that the strain of each of the pair of shaft parts 11 is made uniform.

Different types of identification information may be set to each of the pair of shaft parts 11. In this case, the transmission unit 16 transmits identification information set in the shaft part 11, in which the transmission unit 16 is embedded, to the measurer 20 by radio communication. The storage unit 207 stores the identification information set for each shaft part 11. Further, the storage unit 207 stores data related to the strain of the shaft part 11 collected by the data collection unit 206 about the shaft part 11 in association with the identification information of the shaft part 11. By providing the storage unit 207, the past measurement data can be referred to for each of the pair of shaft parts 11.

When different types of identification information are set to each of the pair of shaft parts 11, the transmission unit 16 embedded in each of the pair of shaft parts 11 may wirelessly transmit a signal at the same frequency or may wirelessly transmit a signal at different frequencies. When the transmission unit 16 embedded in each of the pair of shaft parts 11 wirelessly transmits a signal at different frequencies, the identification information is distributed for each frequency, thereby enabling efficient management of measurement data.

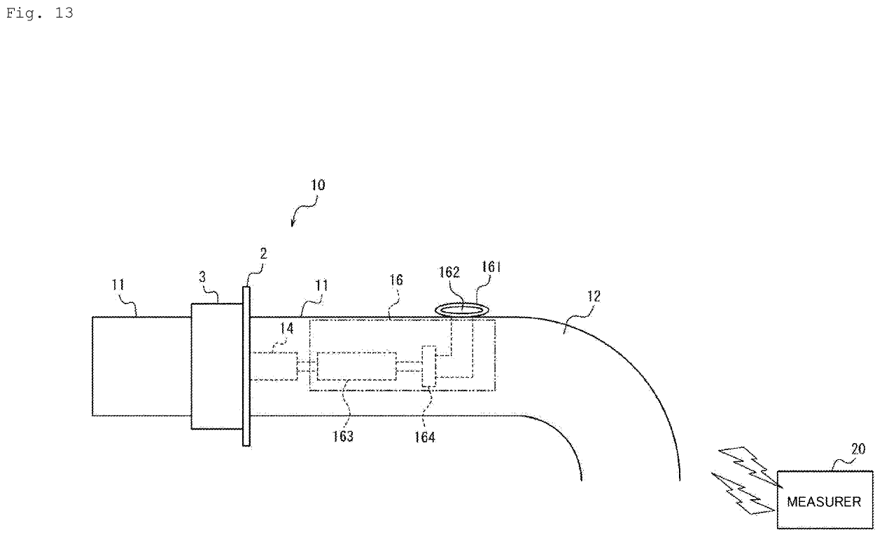

In FIGS. 9 to 12, the transmission unit 16 is disposed closer to the other end side of the shaft part 11 than the strain gauge 14. In such a configuration, when the nut 3 is fastened to the shaft part 11, there is a risk of damage to the power reception coil 161 and the transmission antenna 162 by a tool or the like. Therefore, as shown in FIG. 13, the transmission unit 16 may be embedded closer to one end side of the shaft part 11, that is, the bridge part 12 side, than the strain gauge 14. The mounting positions of the transmission unit 16, especially the power reception coil 161 and the transmission antenna 162, may be located closer to the bridge part 12 than the fastening part of the nut 3.

When the transmission unit 16 measures the strain of the shaft part 11 of the U-bolt 10 embedded closer to the bridge part 12 than the strain gauge 14, the worker performs radio communication by bringing the measurer 20 closer to the U-bolt 10 from the bridge part 12 side as shown in FIG. 13. By providing the transmission unit 16 on the bridge part 12 side, the risk of damage or the like of the transmission unit 16 due to the attachment of the nut 3 is reduced, and the U-bolt 10 can be more safely installed. The measurer 20 may have a configuration in which signals can be simultaneously received from both the transmission units 16 embedded in each of the pair of shaft parts 11, as shown in FIG. 12.

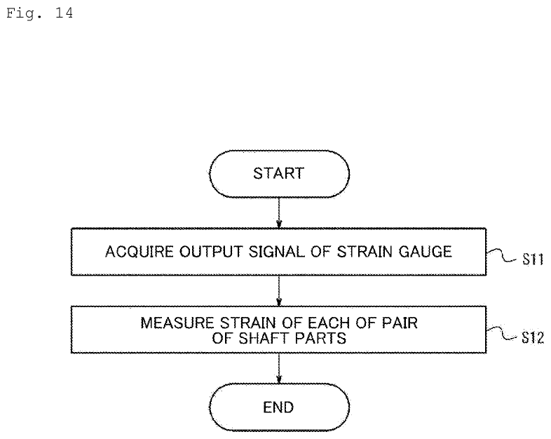

Next, an installing method of the U-bolt 10 according to the present embodiment using the measurer 20 will be described with reference to the flowchart shown in FIG. 14.

The measurer 20 acquires an output signal of the strain gauge 14 embedded in each of the pair of shaft parts 11 (S11). As described above, the measurer 20 acquires the output signal of the strain gauge 14, for example, via the wiring 15 drawn out from the U-bolt 10. The measurer 20 acquires the output signal of the strain gauge 14, for example, by radio communication with the transmission unit 16 embedded in the shaft part 11 of the U-bolt 10. When the measurer 20 acquires the output signal of the strain gauge 14 by radio communication, for example, power is supplied from the measurer 20 to the U-bolt 10 by wireless power supply via an electric field or a magnetic field, and the output signal of the strain gauge 14 is transmitted to the measurer 20 according to the power supply. Therefore, a worker can measure the strain of the shaft part 11 only by performing a simple operation of bringing the measurer 20 close to the U-bolt 10.

Next, the measurer 20 measures the strain in the Y-axis direction of each of the pair of shaft parts 11 from the acquired output signal of the strain gauge 14 (step S12). The measurer 20 displays the measurement result on the display unit 21. Since the measurement result of the strain is displayed on the display unit 21, a worker can adjust fastening force of the nut 3 fastened to each of the pair of shaft parts 11 so that the strain of the pair of shaft parts 11 becomes uniform, while viewing the display of the display unit 21.

Thus, the U-bolt 10 according to the present embodiment includes a pair of shaft parts 11 aligned in the X-axis direction (the first direction) and extending in the Y-axis direction (the second direction) orthogonal to the X-axis direction, a bridge part 12 that connects one end of each of the pair of shaft parts 11, and a strain gauge 14 embedded in each of the pair of shaft parts 11 symmetrically in the X-axis direction.

The installing system 100 according to the present embodiment includes a U-bolt 10 and a measurer 20. The measurer 20 measures the strain in the Y-axis direction of each of the pair of shaft parts 11 from the output signal of the strain gauge 14 embedded in each of the pair of shaft parts 11.

According to fastening of the nut 3 to the shaft part 11 of the U-bolt 10, an output signal corresponding to the strain of the shaft part 11 is output from the strain gauge 14 embedded in the shaft part 11. By measuring the strain of each of the pair of shaft parts 11 from the output signal, a worker can uniformly fix the pair of shaft parts 11. Further, since there is no need for a special structure such as the shaft part 11 having a tapered shape, complication of the structure of the U-bolt 10 can be suppressed.

The present disclosure is not limited to the configurations specified in the above-described embodiments, and various modifications are possible within the scope not departing from the gist of the present invention described in the claims. For example, the functions and the like included in the constituent elements and the like can be redisposed so as not to be logically inconsistent, and multiple constituent elements and the like can be combined into one or divided.

### REFERENCE SIGNS LIST

1 Fastening object
2 Fastening object
2A, 2B Through-hole
3A, 3B Nut
4A, 4B Washer
10 U-bolt
11A, 11B Shaft part
12 Bridge part
13 Screw part
14A, 14B Strain gauge
15A, 15B Wiring
16 Transmission unit
161 Power reception coil
162 Transmission antenna
163 Amplifier
164 Radio transmitter
20 Measurer (measurement device)
21 Display unit
22 Recording unit
201 Power transmission coil
202 Reception antenna
203 Power source
204 High-frequency power source
205 Receiver
206 Data collection unit
207 Storage unit
208 Shield

1. An installing system comprising:
a U-shaped U-bolt,
wherein the U-shaped U-bolt includes a pair of shaft parts and a bridge part, the pair of shaft parts are aligned in a first direction and placed in a second direction, the second direction is orthogonal to the first direction, and the bridge part connects one end of each of the pair of shaft parts; and
a measurement device,
wherein the measurement device includes a strain gauge, the strain gauge outputs a signal corresponding to a strain of the shaft part in the second direction, the strain gauge is embedded in each of the pair of shaft parts, in line symmetry with respect to a straight line, the straight line includes an apex of the U-shape and extends in the second direction, and
the measurement device measures the strain of each of the pair of shaft parts in the second direction, from an output signal of the strain gauge embedded in each of the pair of shaft parts.

2. The installing system according to claim 1, wherein
the U-bolt is fixed by inserting the pair of shaft parts into a pair of through-holes provided in a fastening object, the U-bolt is further fixed by fastening a nut from the other ends of each of the pair of shaft parts, the fastening object is sandwiched between the U-bolt and the fastened object, and
the strain gauge is embedded between a contact point between the fastening object and the U-bolt from a fastening position between the nut and the shaft part.

3. The installing system according to claim 1, wherein
the measurement device is connected to the strain gauge, and the measurement device acquires an output signal of the strain gauge via a wiring drawn out from the shaft part or the bridge part.

4. The installing system according to claim 1, further comprising:
the measurement device acquires the output signal of the strain gauge wirelessly, wherein the strain gauge is embedded in each of the pair of shaft parts.

5. The installing system according to claim 4, wherein
the transmission unit includes a power reception coil, a transmission antenna, and a radio transmitter, the radio transmitter is driven by power supplied via the power reception coil, the radio transmitter transmits the output signal of the strain gauge via the transmission antenna,
the measurement device includes a high-frequency power source and a receiver, the high-frequency power source outputs high-frequency power, and the receiver receives a signal transmitted via the transmission antenna in response to an output of the high-frequency power by the high-frequency power source.

6. The installing system according to claim 4, wherein
the transmission unit embedded in one shaft part of the pair of shaft parts and the transmission unit embedded in the other shaft part of the pair of shaft parts wirelessly transmit the output signal of the strain gauge at different frequencies.

7. A method for installing a measurement device for fixing a U-shaped U-bolt to a fastening object,
wherein, in the U-bolt, a strain gauge which outputs a signal corresponding to a strain of the shaft part in the second direction is embedded in each of the pair of shaft parts, in line symmetry with respect to a straight line including an apex of the U-shape and extending in the Y-axis direction,
the method comprising:
acquiring an output signal of the strain gauge embedded in each of a pair of shaft parts, wherein the U-bolt is U-shaped, the U-bolt includes the pair of shaft parts and a bridge, each of the pair of shaft parts is aligned in a first direction, the U-bolt extends in a second direction, the second direction is orthogonal to the first direction, the bridge connects both ends of each of the pair of shaft parts, the strain gage is in the U-bolt, the strain gauge outputs a signal corresponding to a strain of the shaft part in the second direction, the strain gauge is embedded in each of the pair of shaft parts in line symmetry with respect to a straight line, and the straight line includes an apex of the U-shape and extends in the Y-axis direction; and
measuring strain in the second direction of each of the pair of shaft parts from the acquired signal.

8. A U-shaped U-bolt comprising:
a pair of shaft parts, wherein both shaft parts of the pair of shaft parts are aligned in a first direction and placed in a second direction orthogonal to the first direction; and
a bridge part, wherein the bridge part connects one ends of each of the pair of shaft parts,
the U-shaped U-bolt comprises a strain gauge, the strain gauge is embedded in each of the pair of shaft parts in line symmetry with respect to a straight line, the straight line includes an apex of the U-shape and extends in the Y-axis direction, and the strain gauge outputs a signal corresponding to a strain of the shaft part in the second direction.

9. The installing system according to claim 2, wherein
the measurement device is connected to the strain gauge, and the measurement device acquires an output signal of the strain gauge via a wiring drawn out from the shaft part or the bridge part.

10. The installing system according to claim 2, further comprising:
a transmission unit which wirelessly transmits the output signal of the strain gauge is embedded in each of the pair of shaft parts, wherein
the measurement device acquires the output signal of the strain gauge wirelessly transmitted from the transmission unit.

11. The method according to claim 7, wherein
the U-bolt is fixed by inserting the pair of shaft parts into a pair of through-holes provided in a fastening object, the U-bolt is further fixed by fastening a nut from the other ends of each of the pair of shaft parts, the fastening object is sandwiched between the U-bolt and the fastened object, and
the strain gauge is embedded between a contact point between the fastening object and the U-bolt from a fastening position between the nut and the shaft part.

12. The method according to claim 7, wherein
the measurement device is connected to the strain gauge, and the measurement device acquires an output signal of the strain gauge via a wiring drawn out from the shaft part or the bridge part.

13. The method according to claim 7, further comprising:
wirelessly transmitting, by a transmission unit, the output signal of the strain gauge, wherein the strain gauge is embedded in each of the pair of shaft parts, and
acquiring, by the measurement device, the output signal of the strain gauge wirelessly, wherein the strain gauge is embedded in each of the pair of shaft parts.

14. The method according to claim 13, wherein
the measurement device includes a high-frequency power source and a receiver, the high-frequency power source outputs high-frequency power, and the receiver receives a signal transmitted via the transmission antenna in response to an output of the high-frequency power by the high-frequency power source.

15. The U-shaped U-bolt according to claim 8, wherein
the U-bolt is fixed by inserting the pair of shaft parts into a pair of through-holes provided in a fastening object, the U-bolt is further fixed by fastening a nut from the other ends of each of the pair of shaft parts, the fastening object is sandwiched between the U-bolt and the fastened object, and
the strain gauge is embedded between a contact point between the fastening object and the U-bolt from a fastening position between the nut and the shaft part.
